(19) United States
(12) Patent Application Publication
(10) Pub. No.: US 2024/0235827 A1
(43) Pub. Date: Jul. 11, 2024

(54) FACE-BASED KEY GENERATION

(71) Applicant: REALNETWORKS LLC, Seattle, WA (US)

(72) Inventors: Weitong Chen, Seattle, WA (US); Reza Rassool, Seattle, WA (US)

(21) Appl. No.: 18/352,023

(22) Filed: Jul. 13, 2023

Related U.S. Application Data
(60) Provisional application No. 63/478,877, filed on Jan. 6, 2023.

(51) Int. Cl. H04L 9/08; G06V 10/74; G06V 40/16; G06V 40/50; H04L 9/14

(52) U.S. Cl. CPC H04L 9/0866; G06V 10/761; G06V 40/168; G06V 40/53; H04L 9/14

(57) ABSTRACT

A system includes a camera and a computing device. The computing device receives images captured by the camera and generates a face signature for a person in the images. Significant features are identified in the face signature. And a subset of those significant features are selected and used to generate a binary cryptographic key for the person.

### TECHNICAL FIELD

The present disclosure is related generally to encryption, and particularly to generating a unique cryptographic key from a person's face.

### BACKGROUND

### Description of the Related Art

Technology continues to advance, with more and more information becoming digitally stored and accessible. To protect digital information, various encryption technologies can be utilized. These encryption technologies generally rely on the user authenticating themselves by inputting a long, complicated password. In recent years, the accessibility of cameras and the advancement of facial recognition techniques have allowed for user authentication to be performed using facial images of the user. These facial recognition techniques often rely on specific facial features or consistent facial expressions. Unfortunately, these specific facial features may not be unique enough to distinguish one person from another or it can be difficult for a person to maintain the same facial expression. It is with respect to these and other considerations that the embodiments described herein have been made.

### BRIEF SUMMARY

Briefly described, embodiments are directed toward systems and methods of encrypting content using a binary cryptographic key that is generated for a person using a subset of significant features in images of the person. In this way, a unique key is generated for a person using their face biometric information, while also enabling the person to generate a new unique key from the same face biometric information. Embodiments described herein utilize a list of indices to identify stable significant features and the order in which the bits of the cryptographic key are generated from those significant features. This allows for selection of features to input into key generation with a quantifiable key performance, which allows for more accurate and robust systems for performing content encryption and image authentication of a person.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of embodiments of the present disclosure, reference will be made to the following Detailed Description, which is to be read in association with the accompanying drawings.

FIG. 1 is an example environment in which images of a person are obtained and processed in accordance with embodiments described herein;

FIG. 2A is a context diagram of one non-limiting embodiment of a block diagram illustrating a system for encrypting content using a cryptographic key generated for a person from an image face signature in accordance with embodiments described herein;

FIG. 2B is a context diagram of one non-limiting embodiment of a block diagram illustrating a system for decrypting content using a cryptographic key generated for a person from an image face signature in accordance with embodiments described herein;

FIG. 3 is a logical flow diagram showing one embodiment of a process for encrypting content from a cryptographic key generated for a person from an image face signature in accordance with embodiments described herein;

FIGS. 4A-4C illustrate a logical flow diagram showing a more detailed embodiment of a process for generating a cryptographic key for a person from an image face signature to use in encrypting content in accordance with embodiments described herein;

FIG. 5 is a logical flow diagram of one embodiment of a process to decrypt content for a person using a cryptographic key generated for the person from an image face signature determine in accordance with embodiments described herein;

FIG. 6 is an example illustration of a face similarity matrix used to discard dissimilar face images in accordance with embodiments described herein;

FIG. 7 is an example illustration of a face similarity plot used to discard dissimilar face images in accordance with embodiments described herein;

FIG. 8 is an example illustration of a face feature significance statistics histogram in accordance with embodiments described herein;

FIG. 9 is an example illustration of a cryptographic key generation from randomly selected significant feature in accordance with embodiments described herein; and

FIG. 10 is a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including, but not limited to, the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment.” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof.” and lists with additional elements are similarly treated. The term “based on” is not exclusive, and allows for being based on additional features, functions, aspects, or limitations not described, unless the context clearly dictates otherwise. In addition, throughout the specification, the meaning of “a,” “an.” and “the” include singular and plural references.

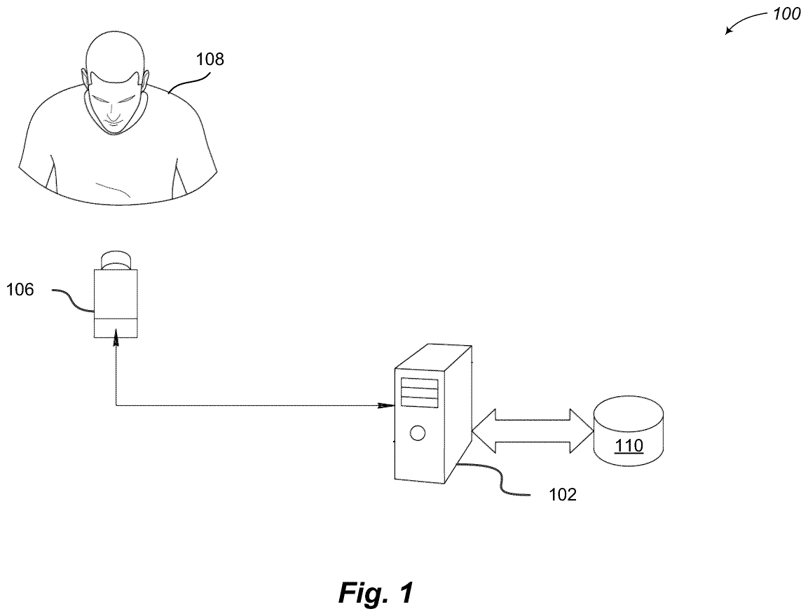

FIG. 1 is an example environment 100 in which images of a person 108 are obtained and processed in accordance with embodiments described herein. The environment 100 includes a camera 106, a computing device 102, and a content database 110. In this example, the person 108, also referred to as a user, is attempting to encrypt content (e.g., a document or personal information) or to decrypt previously encrypted content (e.g., an encrypted document or encrypted personal information) using facial authentication and authorization. In other situations and embodiments, the person 108 may be attempting to gain access through a door, unlock or gain access to a computing device (e.g., a smart phone or tablet computer), make online payments, take remote tests, perform secure banking, or otherwise use facial authentication and authorization to perform a secure computing functions or actions.

When the person 108 is attempting to encrypt content, the person 108 positions himself or herself in front of camera 106. The computing device 102 utilizes embodiments described herein to capture images of the person 108 via camera 106 and to generate a binary cryptographic key for the person 108. The computing device 102 can obtain content (e.g., content that is stored in the content database 110) and encrypt that content using the generated binary cryptographic key.

When the person 108 is ready to decrypt the previously encrypted content, the person 108 positions himself or herself in front of camera 106. The computing device 102 utilizes embodiments described herein to capture images of the person 108 via camera 106 and to re-generate the binary cryptographic key for the person 108. The computing device 102 can then decrypt the content using the re-generated binary cryptographic key. Although described as a single computing device, computing device 102 may include one or multiple computing devices or systems. For example, one computing device may perform the content encryption and a separate second computing device may perform the decryption.

In some embodiments, the computing device 102 may include or be in communication with the content database 110 via a network (not illustrated). The content database 110 may store unencrypted content or encrypted content. In some embodiments, the computing device 102 may include the content database 110. In other embodiments, the content database 110 may be separate from the computing device 102.

In various embodiments, the generated binary cryptographic key itself is not stored or maintained after the content is encrypted. Rather, as described herein, the selected significant face-signature feature indices used to generate the binary cryptographic key are maintained. For example, the selected indices may be included or stored with the encrypted content (e.g., as metadata) or they may be stored separately (e.g., by content database 110). In some embodiments, the same selected indices, and thus generating the same binary cryptographic key, may be used to encrypt separate content. In other embodiments, embodiments described herein may be employed independently for separate content, which could result in different sets of indices being selected, and thus generating different binary cryptographic keys, for the separate content.

In some other embodiments, the generated binary cryptographic key itself may be stored for other purposes, such as for gaining access through a door, unlocking or gaining access to a computing device, making online payments, taking remote tests, performing secure banking, or otherwise using facial authentication and authorization to perform a secure computing functions or actions. In such situations, separately generated cryptographic keys are stored for one or more people. In some embodiments, a person may have one key generated and stored for one or multiple purposes. In other embodiments, a person may have a plurality of keys generated and stored for different purposes. Accordingly, one or more binary cryptographic keys may be generated and stored for each of one or more people. In some embodiments, significant face-signature feature indices may be stored for each person with their binary cryptographic keys. In other embodiments, the significant feature indices for the person may be stored separate from the keys, but identifiable to the corresponding person. In this way, when a person needs to use facial authentication and authorization to perform some function, the person positions himself or herself in front of the camera and the computing device 102 utilizes embodiments described herein to capture images of the person to re-generate the binary cryptographic key for that person. This regenerated binary cryptographic key can be compared to the previously stored binary cryptographic key or keys for the person. If there is a match for the function being requested by the person, then the person is positively authenticated and the function is performed. If there is no match, then the authentication is negative and performance of the function is prohibited.

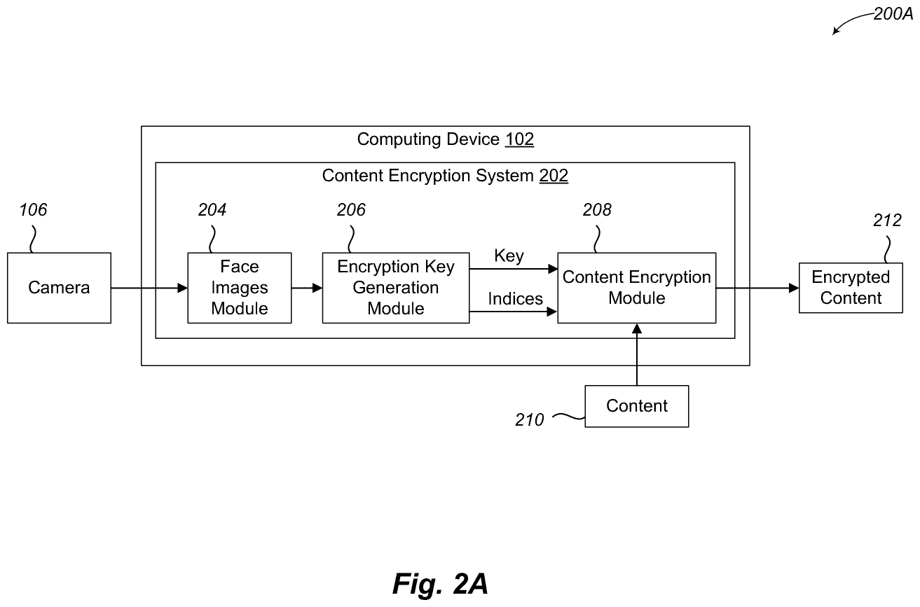

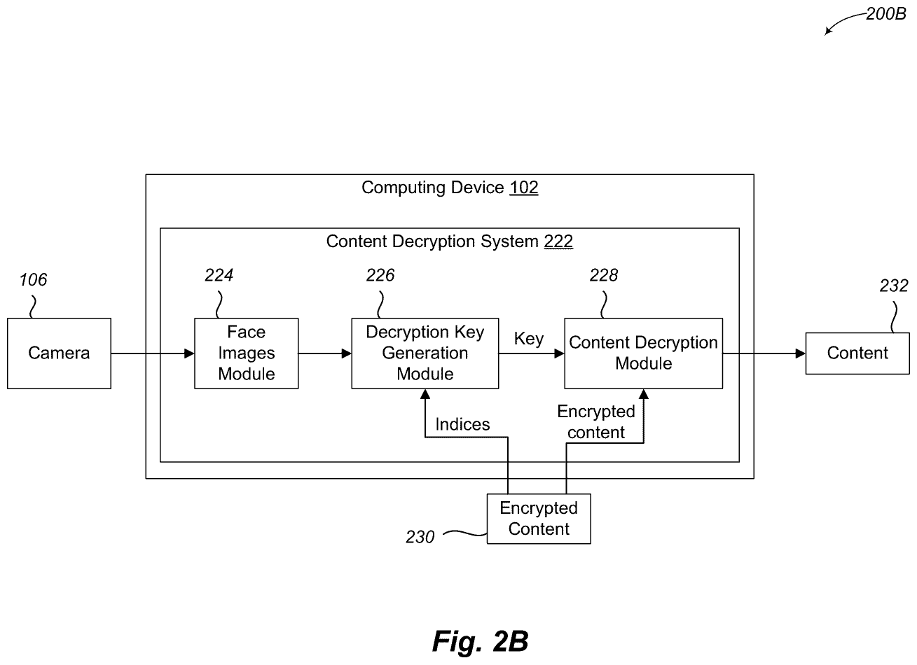

FIG. 2A is a context diagram of one non-limiting embodiment of a block diagram illustrating a system 200A for encrypting content using a cryptographic key generated for a person from an image face signature in accordance with embodiments described herein. System 200A includes a camera 106 and a computing device 102, similar to environment 100 in FIG. 1.

The computing device 102 includes a content encryption system 202. The content encryption system 202 includes a face images module 204, an encryption key generation module 206, and a content encryption module 208.

The face images module 204 is configured to obtain and manage images captured or obtained from the camera 106. In some embodiments, the face images module 204 may preprocess the images prior to key generation, such as by filtering out dissimilar faces or low-quality face images, as described herein. The face images module 204 provides the images to the encryption key generation module 206.

The encryption key generation module 206 is configured to generate a binary cryptographic key for a person's face from the images captured by the camera 106, as described herein. Briefly, the encryption key generation module 206 analyzes each image of the user's face to identify and select significant face-signature features of the user's face. The encryption key generation module 206 generates the binary cryptographic key using values of the selected significant features. The encryption key generation module 206 provides the generated binary cryptographic key and the indices of the selected significant features to the content encryption module 208.

The content encryption module 208 is configured to receive the binary cryptographic key and the indices of the selected significant features from the encryption key generation module 206. The content encryption module 208 obtains or accesses content 210, as selected by the person for encryption. In some embodiments, content 210 may have been stored on content database 110 in FIG. 1 or some other computing system. The content encryption module 208 encrypts content 210 using the binary cryptographic key received from the encryption key generation module 206 to generate encrypted content 212. The content encryption module 208 also modifies encrypted content 212 to include the indices of the selected significant features received from the encryption key generation module 206. In various embodiments, the indices are stored in the metadata or a header of the encrypted content 212. In other embodiments, the indices may be stored separate or remotely from the encrypted content 212, such as in database 110. The encrypted content 212 may also include other information regarding the mechanism used to generate the binary cryptographic key (e.g., biometric feature extraction method, version, number of bits, etc.).

Although the face images module 204, the encryption key generation module 206, and the content encryption module 208 are illustrated as separate modules or components, embodiments are not so limited. Rather, one or a plurality of modules or components may be employed to perform the functionality of the face images module 204, the encryption key generation module 206, and the content encryption module 208.

FIG. 2B is a context diagram of one non-limiting embodiment of a block diagram illustrating a system 200B for encrypting content using a cryptographic key generated for a person from an image face signature in accordance with embodiments described herein. System 200B includes a camera 106 and a computing device 102, similar to environment 100 in FIG. 1.

The computing device 102 includes a content decryption system 222. The content decryption system 222 includes a face images module 224, a decryption key generation module 226, and a content decryption module 228.

The face images module 224 is configured to obtain and manage images captured or obtained from the camera 106. In various embodiments, the face images module 224 may employ embodiments of, or be the same module as, the face images module 204 in FIG. 2A to preprocess the images prior to key generation. The face images module 224 provides the images to the decryption key generation module 226.

The decryption key generation module 226 is configured to regenerate a binary cryptographic key for a person's face from the images captured by the camera 106, as described herein. Briefly, the decryption key generation module 226 receives the indices of the selected significant features for encrypted content 230, such as from the metadata of encrypted content 230. The decryption key generation module 226 analyzes each image of the user's face to identify significant features of the user's face and selects those features associated with the received indices to regenerate the binary cryptographic key. The decryption key generation module 226 provides the regenerated binary cryptographic key to the content decryption module 228.

The content decryption module 228 is configured to receive the regenerated binary cryptographic key from the decryption key generation module 226. The content decryption module 228 obtains or accesses encrypted content 220, as selected by the person for decryption. In some embodiments, encrypted content 230 may have been stored on content database 110 in FIG. 1 or some other computing system. The content decryption module 228 decrypts encrypted content 230 using the regenerated binary cryptographic key received from the decryption key generation module 226 to generate content 232.

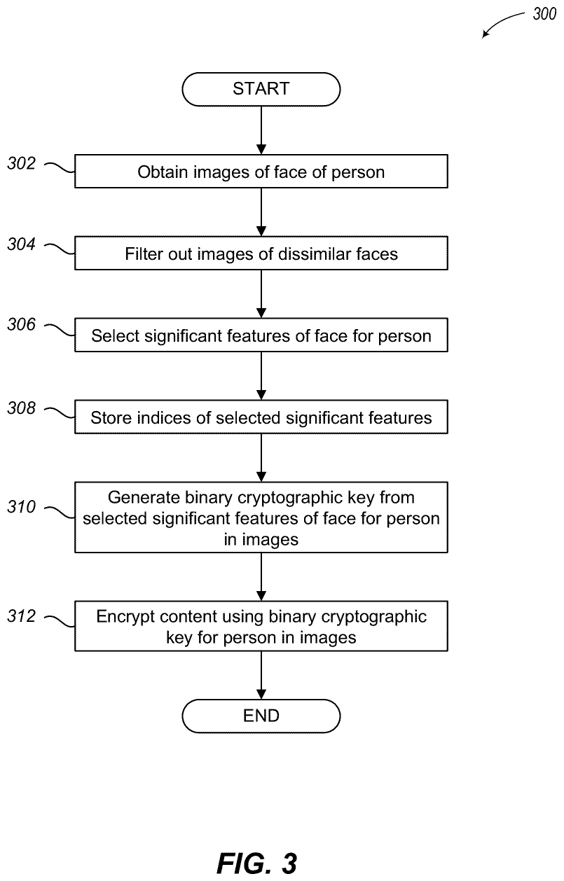

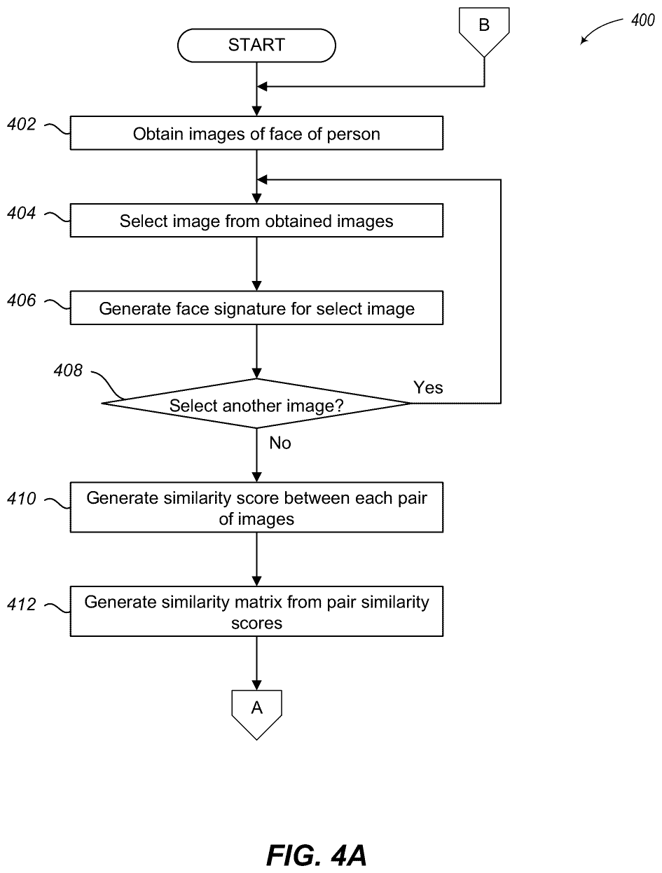

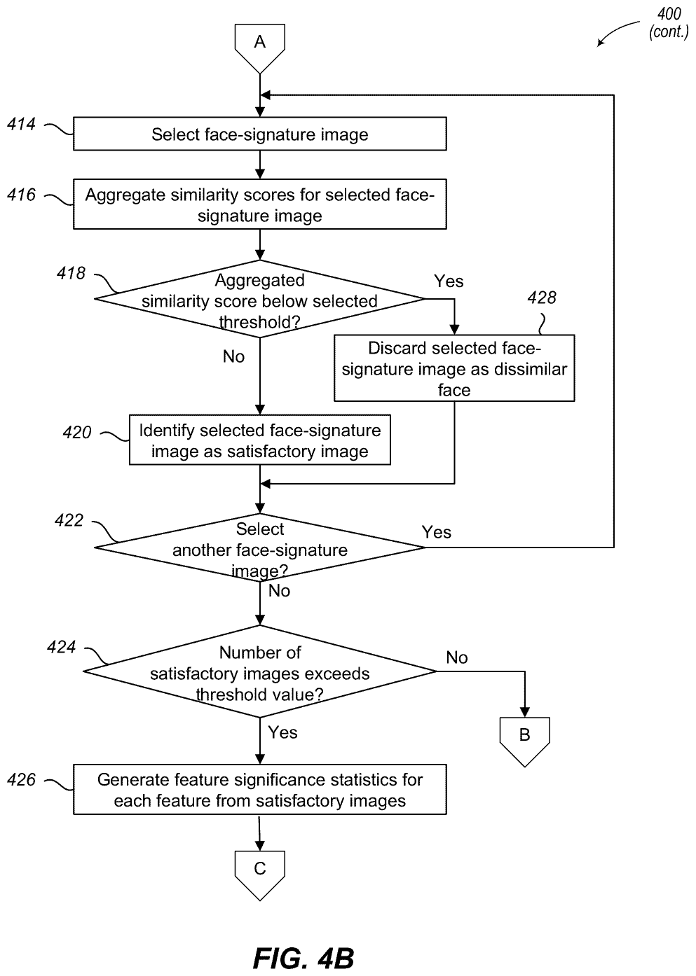

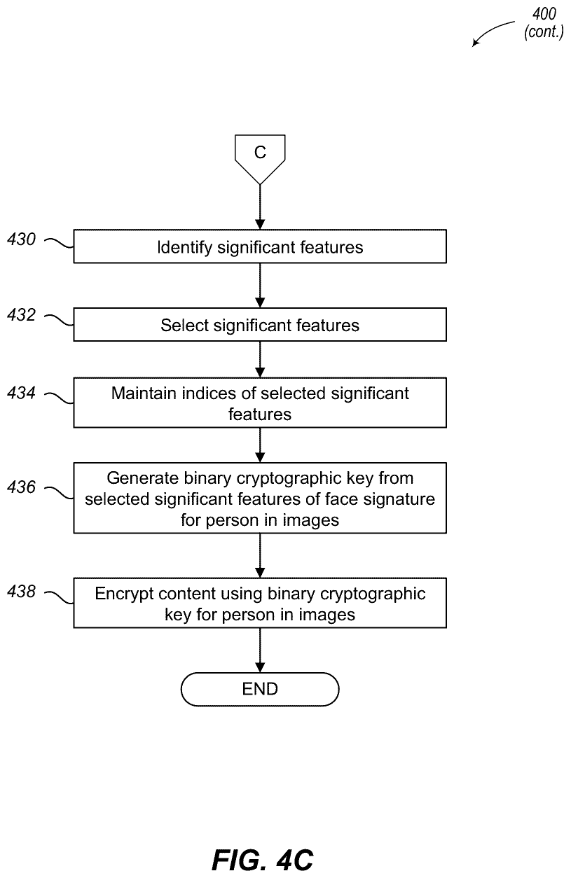

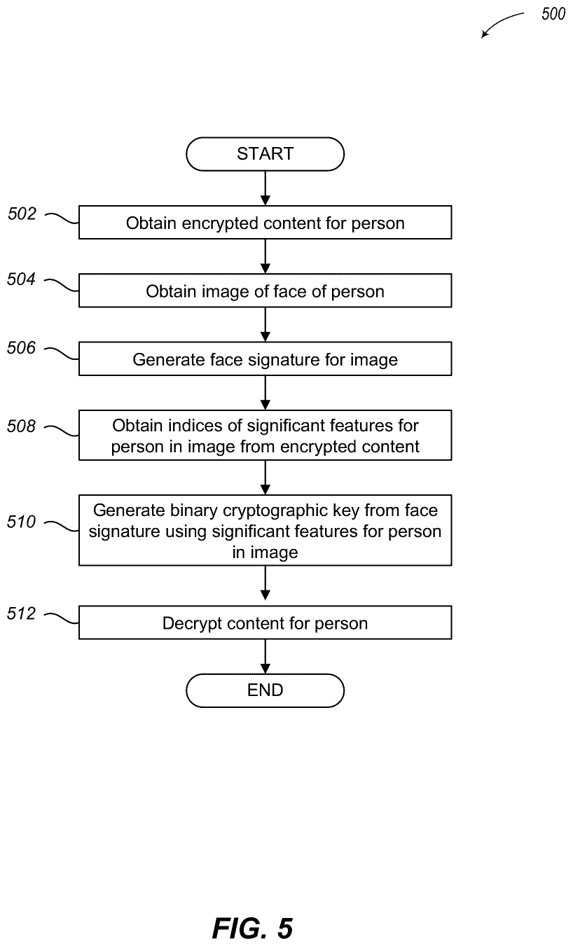

The operation of certain aspects will now be described with respect to FIGS. 3, 4A-4C, and 5. Processes 300 and 400 described in conjunction with FIGS. 3 and 4A-4C, respectively, may be implemented by or executed on one or more computing devices or systems, such as content encryption system 202 in FIG. 2A. Process 500 described in conjunction with FIG. 5 may be implemented by or executed on one or more computing devices or systems, such as content decryption system 222 in FIG. 2B.

FIG. 3 is a logical flow diagram showing one embodiment of a process 300 for encrypting content from a cryptographic key generated for a person from an image face signature in accordance with embodiments described herein. In some embodiments, process 300 may be considered to be the calibration or initialization process that generates the binary cryptographic key for authentication and authorization, depending on the person's purposes for authentication and authorization.

Process 300 begins, after a start block, at block 302, where one or a plurality of images of a person's face are obtained. The person may be positioned in front of a camera prior to or after selecting which content is to be encrypted, such that the images of the person's face are captured in real time. In other embodiments, the images may have been previously captured of the person's face.

Process 300 proceeds after block 302 to block 304, where images having dissimilar faces are filtered out. Various facial similarity techniques may be employed. In some embodiments, blocks 404, 406, 408, 410, 412, 414, 416, 418, 420, 422, and 428 in FIGS. 4A and 4B may be utilized to filter out dissimilar face images.

Process 300 continues after block 304 at block 306, where a plurality of selected significant features of the person's face are selected. In various embodiments, each image of the person's face is analyzed to identify features of the person's face. These features may be referred to as face-signature features. In some embodiments, each of a plurality of features is given a numerical value (e.g., a floating point number). In some embodiments, the features may be identified over time by employing machine learning or artificial intelligence techniques on a plurality of training images of a plurality of different people. After multiple iterations or learning sessions, the identified features may not directly correspond to a person's actual facial features. In at least one such embodiment, each separate feature of the plurality of features is given a unique index value. For example, if there are 460 features, the first feature may be assigned index value 1, the second feature may be assigned index value 2, and so on so the last feature is assigned index value 460. In other embodiments, the features may be actual facial features, such as a state of the mouth (e.g., whether the mouth is open, whether the mouth is smiling), a state of the eyes (e.g., whether the eyes are open, a gaze direction of the eyes), positioning of the eyes relative to the mouth or nose, skin color, position of hair line relative to the eyes, position of the chin relative to the mouth, shape of chin, shape of mouth, shape of eyes, positioning of eyebrows, etc.

In various embodiments, significant features may be randomly selected from those features having a threshold uniqueness to the person. In at least one embodiment, blocks 426, 430, and 432 in FIGS. 4B and 4C may be utilized to select the significant features.

Process 300 proceeds after block 306 to block 308, where indices of the selected significant features are maintained. As noted herein, each of the plurality of features being analyzed in the person's face has a corresponding index value. Those index values of the selected significant features are maintained or stored so that they can be later used to regenerate the binary cryptographic key for the person when the person needs to be authenticated (e.g., as described in more detail below in conjunction with FIG. 5).

Process 300 continues after block 308 at block 310, where the binary cryptographic key is generated for the person. In at least one embodiment, each binary digit in the binary cryptographic key corresponds to one of the selected significant features. In various embodiments, the order of the binary digits may be in numerical order of the index values of the selected significant features, with a lowest index being the first binary digit in the binary cryptographic key, the second lowest index being the second binary digit in the binary cryptographic key, and so on. In other embodiments, the significance of the selected significant features may be used to order the digits in the binary cryptographic key. For example, a selected significant feature having a highest significance value would correspond to the first bit in the binary cryptographic key, a selected significant feature having a second highest significance value would correspond to the second bit in the binary cryptographic key, etc.

In various embodiments, the binary cryptographic key is generated from the values of the selected significant features. In some embodiments, each selected significant feature may have a value from −1 (negative one) to 1 (positive one) based on the analysis of the person's face in the image. Negative values are assigned a binary 0 (zero) in the binary cryptographic key and positive values are assigned a binary 1 (one) in the binary cryptographic key based on the corresponding order of the selected significant features.

In various embodiments, this generated binary cryptographic key may be modified or combined with one or more other cryptographic keys for extra security. For example, if the content being encrypted are medical records for a patient, then the generated binary cryptographic key for the patient may be combined with a cryptographic key for the doctor. Such an additional cryptographic key may be generated based on a password or by employing embodiments described herein using the doctor's face. Such multiple cryptographic keys may be concatenated together, interleaved together at a selected pattern, etc.

Process 300 proceeds after block 310 to block 312, where content is encrypted using the binary cryptographic key for the person in the images. If multiple cryptographic keys are combined, then the combined cryptographic key is used to encrypt the content.

In some embodiments, the encrypted content is modified to include the significant feature indices, but in other embodiments the significant feature indices are stored separately. The encrypted content may be further modified to include a header that specifies the biometric feature extraction method, version, or other information to sufficiently to allow for key regeneration.

After block 312, process 300 terminates or otherwise returns to a calling process to perform other actions.

As one non-limiting example, the content may be personal information, such as medical information. By employing embodiments described herein, medical information of an elderly person can be encrypted without the need to have the person remember a password.

FIGS. 4A-4C illustrate a logical flow diagram showing a more detailed embodiment of a process 400 for generating a cryptographic key for a person from an image face signature to use in encrypting content in accordance with embodiments described herein.

Process 400 begins, in FIG. 4A after a start block, at block 402, where one or more images of a face of a person are obtained. In various embodiments, block 402 may employ embodiments of block 302 in FIG. 3 to obtain images of a person's face. In some embodiments, a single image is obtained. In other embodiments, a plurality of images (e.g., 10 or 100) are obtained. In yet other embodiments, the person or an administrator may select the number of images to be captured or obtained.

Process 400 proceeds after block 402 to block 404, where an image is selected from the obtained images. In at least one embodiment, images are selected in an order in which they are captured, such as consecutive image frames in a video stream.

Process 400 continues after block 404 at block 406, where a biometric face signature is generated for the selected image. The face signature may be a list or array or vector of values representative of different face-signature features of the person's face. In some embodiments, each element in the array that makes up the face signature corresponds to a separate feature. The corresponding index value for each feature is its corresponding position within the array of the face signature. Each element stores a numerical value representative of the face-signature feature of the person's face in the selected image. In some embodiments, the numerical value ranges between −1 (negative one) to 1 (positive one). Examples of such features and their values is discussed at block 306 in FIG. 3.

Process 400 proceeds after block 406 to decision block 408, where a determination is made whether another image is selected. As mentioned above, a plurality of images may be obtained and each image is selected in a desired order (e.g., consecutive image frames in a video stream), such that each image is selected once. If another image is to be selected, then process 400 loops to block 404 to select another image and generate a face signature for that image at block 406. If no other image is to be selected, then process 400 proceeds from decision block 408 to block 410.

At block 410, a similarity score is generated between each pair of images. In some embodiments, the similarity score for a pair of images is the dot product between the face signatures of the images in the pair of images. In various embodiments, each similarity score is between 0 (zero) and 1 (positive one). Other image similarity techniques may also be used on the face signatures for the plurality of obtained images, such as a Euclidean clustering, or other distance algorithms or metrics now known or developed in the future, etc.

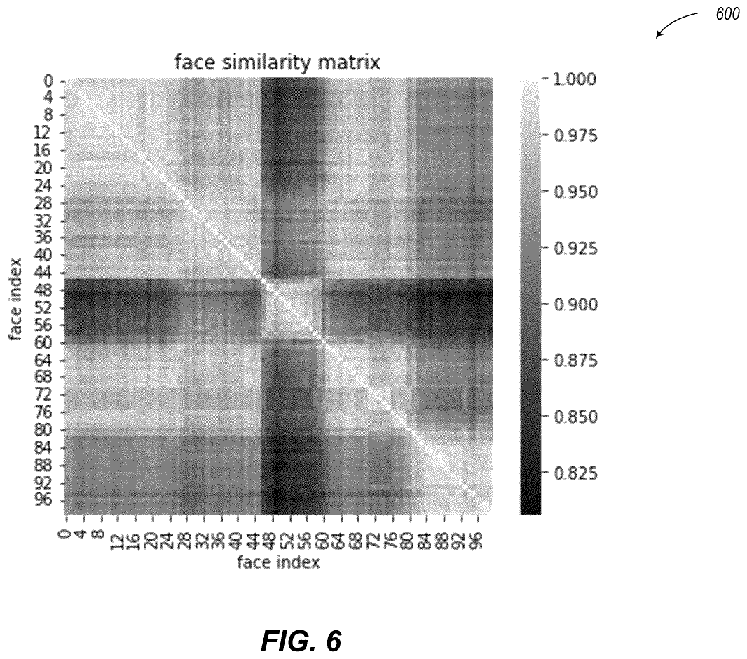

Process 400 continues after block 410 at block 412, where a similarity matrix is generated from the pair of similarity scores. One example of a similarity matrix is shown in FIG. 6, where the similarity score for each image pair is plotted on a matrix with the x and y axes representing each image, such that each intersection on the matrix is an image pair.

Process 400 proceeds after block 412 to block 414 in FIG. 4B, where a face-signature image is selected from the plurality of obtained images. A face-signature image is an image obtained at block 402, but has been processed from which a face signature has been generated at block 406. In various embodiments, the face-signature image is selected from the obtained face images represented on the x-axis of the similarity matrix generated at block 412.

Process 400 continues after block 414 at block 416, where the similarity scores for the selected face-signature image are aggregated. Accordingly, the similarity scores of each image pair that includes the selected face-signature image are aggregated. In some embodiments, this aggregation is the mean of those similarity scores associated with the selected face-signature image. In other embodiments, other statistical values may be derived from the aggregation of the similarity scores, such as the maximum similarity score for the selected face-signature image. In various embodiments, the aggregated similarity score may be between 0 (zero) and 1 (positive one).

Process 400 proceeds after block 416 to decision block 418, where a determination is made whether the aggregated similarity score is below a selected or pre-defined threshold. In some embodiments, the selected threshold may be 0.9 when the aggregated similarity score may be between 0 (zero) and 1 (positive one). Other selected thresholds may also be used based on the mechanism used to calculate the similarity scores or the aggregated similarity score. Moreover, the person or an administrator may modify the selected threshold. If the aggregated similarity score is below the selected threshold, then process 400 flows to block 428; otherwise, process 400 flows to block 420.

At block 428, the selected face-signature image is discarded as being a dissimilar face to the faces in the other obtained images. In this way, images with lower aggregated similarity scores are filtered out and not used for further processing. After block 428, process 400 proceeds to decision block 422.

If, at decision block 418, the aggregated similarity score is above the selected threshold, then process 400 flows from decision block 418 to block 420. At block 420, the selected face-signature image is identified or labeled as being a satisfactory image. A satisfactory image is an image that includes a person's face that is sufficiently similar to the person's face is a separate image. After block 420, process 400 proceeds to decision block 422.

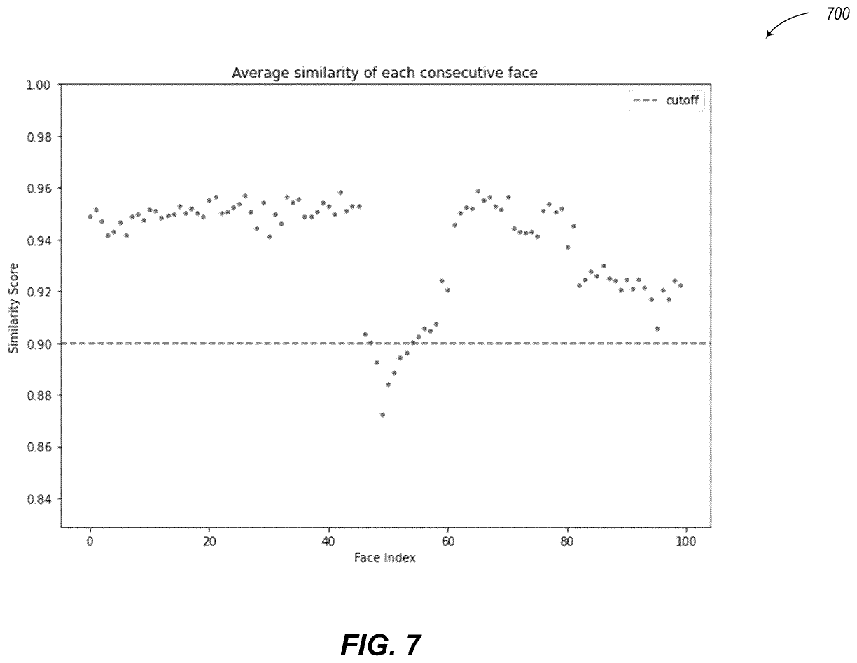

At decision block 422, a determination is made whether another face-signature image is selected. In one embodiment, each image represented on the x-axis of the similarity matrix is individually selected. Accordingly, each obtained image is selected so that an aggregated similarity score can be generated. If another face-signature image is to be selected, process 400 loops to block 414 to select another face-signature image, aggregate its corresponding similarity scores, and determine if it should be discarded or identified as a satisfactory image. If another face-signature image is not selected, then process 400 flows from decision block 422 to decision block 424. FIG. 7 is an illustrative example of the aggregated similarity scores for a plurality of face-signature images, where the discarded images are those images having an aggregated similarity score below the threshold line (e.g., 0.9).

At decision block 424, a determination is made whether the number of satisfactory images exceeds a threshold value. In various embodiments, the person in the images or an administrator may select this threshold value. In one illustrative example, this threshold value is 10 satisfactory images. If the number of satisfactory images does not meet or exceed the threshold value, then process 400 loops to block 402 in FIG. 4A to obtain additional images of the person's face. If the number of satisfactory images meets or exceeds the threshold value, then process 400 flows from decision block 424 to block 426 in FIG. 4B.

At block 426, a feature significance statistic is generated for each of the plurality of features from the satisfactory images. In various embodiments, this feature significance statistic is referred to as a feature significance value or significance value for a feature. These significance statistics for each feature are used to identify significant features, which is discussed in more detail herein (e.g., at block 428 in FIG. 4C). Significant features are features that have a high absolute value among all satisfactory images and have a low standard deviation among all satisfactory images.

In various embodiments, the significance statistic for a feature, also referred to as the feature significance, is defined by the following equation:

$$s = \frac{μ ( \vert Z \vert )}{σ ( \vert Z \vert )} , s ∈ ℝ , Z ∈ {ℝ}^{n}$$

where:
s is a significance value for a particular feature and is a real number;
Z is a vector of the feature values for that particular feature among all satisfactory images, where |Z| is the absolute function of Z;
μ is the mean of the feature values for that particular feature among all satisfactory images; and
σ is the standard deviation of the feature values for that particular feature among all satisfactory images.

These significance statistics enable features stability utilizing strength and variance. Different functions can also be chosen to measure either strength (e.g., magnitude and square root) or variance (e.g., standard deviation and range).

In various embodiments, a lower significance statistic (e.g., close to zero) for a feature indicates that that feature has low significance in distinguishing the person's face from another person's face, and a higher significance statistic for a feature indicates that that feature has a higher significance in distinguishing the person's face from another person's face.

Process 400 proceeds after block 426 to block 430 in FIG. 4C, where the significant features are identified based on the significance statistics for the plurality of features. In various embodiments, a selected percentile threshold (e.g., highest 75^{th} percentile) of the feature significance values for the plurality of features is used to identify the significant features. For example, features having a feature significance value or significance statistic above the selected percentile threshold are identified as significant features. In at least one embodiment, these identified significant features may be referred to as possible significant features from which the ultimate significant features are selected for key generation in block 432.

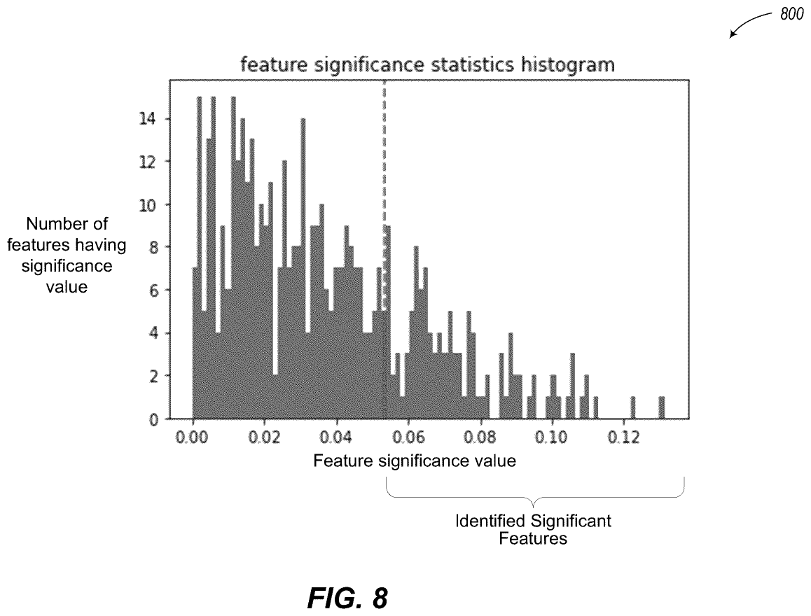

In various embodiments, the significance statistics for the plurality of features can be plotted on a feature significance statistics histogram. One example of a feature significance statistics histogram is illustrated in FIG. 8. In this way, the number of features having a specific feature significance value or significance statistic is calculated for different significance values and plotted on the histogram. Each feature having a feature significance value or significance statistic above a selected percentile threshold is then identified as a significant feature.

Process 400 continues after block 430 at block 432, where a subset of the significant features are selected. In various embodiments, the subset of significant features are randomly selected from the identified significant features. In at least one embodiment, the number of randomly selected significant features is determined based on a selected length of the binary cryptographic key to be generated. For example, if the generated key is to be 64 bits, then 64 significant features are selected. In some embodiments, the person or an administrator may modify the length of bits in the key, and thus modify the number of significant features being selected. In some embodiments, the number of selected significant features may also be determined based on false rejection rate, false match rate, etc. In yet other embodiments, the subset of significant features may be pseudo-randomly selected from the identified significant features based on known stable features that have little variation from one facial expression to another. In some embodiments, more stable features may be provided as feedback for future selection of significant features.

In various embodiments, the generated key may be modified or combined with one or more other cryptographic keys for extra security. In some embodiments, the key generation process described herein may be seed with a user private seed and optionally a service operator seed. The service operator seed is known to the service operator. It could be the user's mobile phone number for example. The user private seed is something only known to user, for example, it could be a security question. The alphanumeric answer and question can be converted into a numeric seed with common encoding methods. The seeds can then be combined into a final indicator that is used to randomly select the indices among the identified significant features. Either the user private seed or the operator seed allows the user to revoke and regenerate a new key.

In various embodiments, if a person's binary cryptographic key is compromised, they can have process 400 repeated, but have a new random subset of significant features selected. In some other embodiments, the subset of significant features may be selected based on a hierarchy or weighted ranking of features, as set or defined by an administrator.

Process 400 continues after block 432 at block 434, where the indices of the selected significant features are maintained, which is similar to block 308 in FIG. 3. As described herein, each separate feature has a position or identity, referred to as the feature index, in the face signature of an image. Each feature has the same feature index from one face signature in one image to the next face signature in another image. These feature indices are maintained or stored specifically for the person whose face is in the images so that they can be used to recreate the binary cryptographic key for the person when that person is attempting authentication, which is described in more detail below in conjunction with FIG. 5.

Process 400 proceeds after block 434 to block 436, where a binary cryptographic key is generated for the person in the image, which is similar to block 310 in FIG. 3. In various embodiments, the binary cryptographic key is generated by binarizing the values of the selected significant features. In some embodiments, the feature values of the selected significant features from a single satisfactory image are used to generate the binary cryptographic key. In other embodiments, an average of the feature values of the selected significant features from a plurality of satisfactory images may be used to generate the binary cryptographic key.

As described herein, the feature values may be between −1 (negative one) and 1 (positive one). Negative selected significant feature values (and zero) are assigned binary zero in the cryptographic key and positive selected significant feature values are assigned binary one. As mentioned herein, the numerical order of the indices of the selected significant features from smallest to largest may be used as the corresponding order of the bits in the binary cryptographic key. In other embodiments, the significance values of the selected significant features may be used to order the digits in the binary cryptographic key from highest significance value to lowest. Other orders may also be used so long as the stored indices indicate the order to be used to generate the binary cryptographic key.

Moreover, this generated binary cryptographic key may be modified or combined with one or more other cryptographic keys for extra security, as described herein.

Process 400 continues after block 436 to block 438, where content is encrypted using the binary cryptographic key for the person in the images, similar to block 312 in FIG. 3. In various embodiments, the encrypted content is modified to include or contain the maintained indices of the selected significant features. In some embodiments, the encrypted content may also be modified to include or contain information indicating if or how the binary cryptographic key generated herein may be modified or combined with one or more other cryptographic keys.

After block 438, process 400 terminates or otherwise returns to a calling process to perform other actions.

FIG. 5 is a logical flow diagram of one embodiment of a process 500 to decrypt content for a person using a cryptographic key generated for the person from an image face signature determine in accordance with embodiments described herein.

Process 500 begins, after a start block, at block 502, where encrypted content is obtained for the person. In various embodiments, the person or an administrator may select the encrypted content that is to be decrypted using a binary cryptographic key regenerated from images of the person's face.

Process 500 continues after block 502 at block 504, where one or more images of the person's face are obtained. This person is the person who is seeking authentication to decrypt content based on a previously generated binary cryptographic key from process 400 in FIG. 4. In some embodiments, the person or an administrator may selected the number of images to obtain. If a plurality of images are obtained, then dissimilar face images may be filtered out, as described herein (e.g., at block 304 in FIG. 3).

Process 500 proceeds from block 504 to block 506, where a face signature in the image is generated. In various embodiments, block 504 may perform embodiments of block 406 to generate the face signature.

Process 500 continues after block 506 at block 508, where the indices of the significant features for the person in the image are obtained. In some embodiments, the indices are extracted from the encrypted content. In other embodiments, a database of indices is accessed to obtain a stored list of significant feature indices specific for the person (or for the encrypted content for that person).

Process 500 proceeds from block 508 to block 510, where a binary cryptographic key is generated, also referred to as re-generated, from the face in the image signature using the significant features associated with the obtained indices. In various embodiments, block 508 may employ embodiments of block 310 in FIG. 3 to generate the binary cryptographic key. If the resulting binary cryptographic key is a combination of the key generated using techniques described herein along with another key, which may be indicated in the metadata of the encrypted content, then the binary cryptographic key is modified or combined with one or more other cryptographic keys.

Process 500 continues after block 510 at block 512, where the encrypted content is decrypted using the generated binary cryptographic key.

After block 512, process 500 terminates or otherwise returns to a calling process to perform other actions.

Although process 500 is described as being used to decrypt previously encrypted content, embodiments are not so limited. If the person is seeking authentication and authorization to perform some other function, then the binary cryptographic key generated at block 510 may be compared to a previously stored binary cryptographic key for the person. If the generated binary cryptographic key matches the previously stored binary cryptographic key for the person, then the person is positively authenticated and the function is performed. But if the generated binary cryptographic key does not match the previously stored binary cryptographic key for the person, then a negative authentication is indicated and the function is prevented from being performed.

Although not illustrated, embodiments described herein may be combined with other mechanisms and tools to determine the liveness of the person in the images, such as described in U.S. patent application Ser. No. 17/698,800, filed on Mar. 18, 2022.

FIG. 6 is an example illustration of a face similarity matrix 600 used to discard dissimilar face images in accordance with embodiments described herein. In this illustrative example, 100 images of a person's face were captured and are being compared to filter out dissimilar images. As described herein, a similarity score is generated between each pair of captured images. These similarity scores are then plotted on the face similarity matrix 600, with each similarity score being plotted as a colored pixel at an x-y coordinate for the image pair within the face similarity matrix 600. The lighter colored plotted pixels indicate that two images are more similar compared to darker colored plotted pixels, with white pixels indicating an exact match between a pair of images.

FIG. 7 is an example illustration of a face similarity plot 700 used to discard dissimilar face images in accordance with embodiments described herein. The similarity scores for each image pair for a corresponding image are aggregated to create single similarity score for that selected image. Considering the face similarity matrix 600 in FIG. 6, the similarity scores along the y-axis for each corresponding image on the x-axis are aggregated for the corresponding image on the x-axis. In this way, each corresponding image on the x-axis is given a single similarity score, which is plotted on the face similarity plot 700 in FIG. 7.

FIG. 8 is an example illustration of a face feature significance statistics histogram 800 in accordance with embodiments described herein. The x-axis identifies a plurality of different feature significance values, and the y-axis is the number of times a feature has that corresponding significance value, as described herein. Using a selected threshold (e.g., the top 25% of features having a highest significance value), a plurality of significant features having significant values above that threshold are identified from the histogram 800, which are used to randomly select significant features for key generation, as described herein.

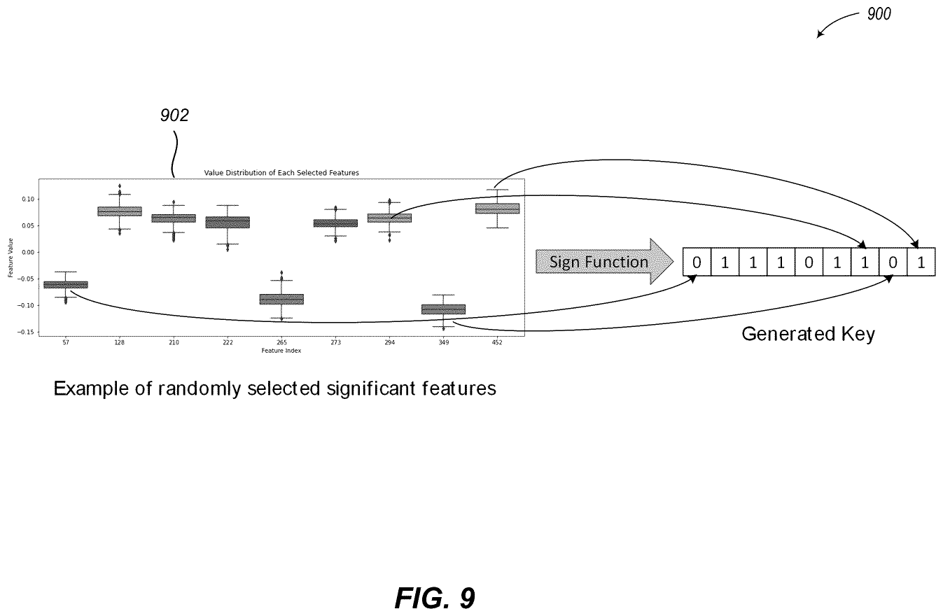

FIG. 9 is an example illustration 900 of a cryptographic key generation from randomly selected significant feature in accordance with embodiments described herein. Graph 902 illustrates the plurality of randomly selected significant features, with their corresponding feature index value being plotted on the x-axis. The feature value itself is plotted on the y-axis of graph 902. As described herein, negative feature values are given a binary zero in the generated key and positive feature values are given a binary one in the generated key.

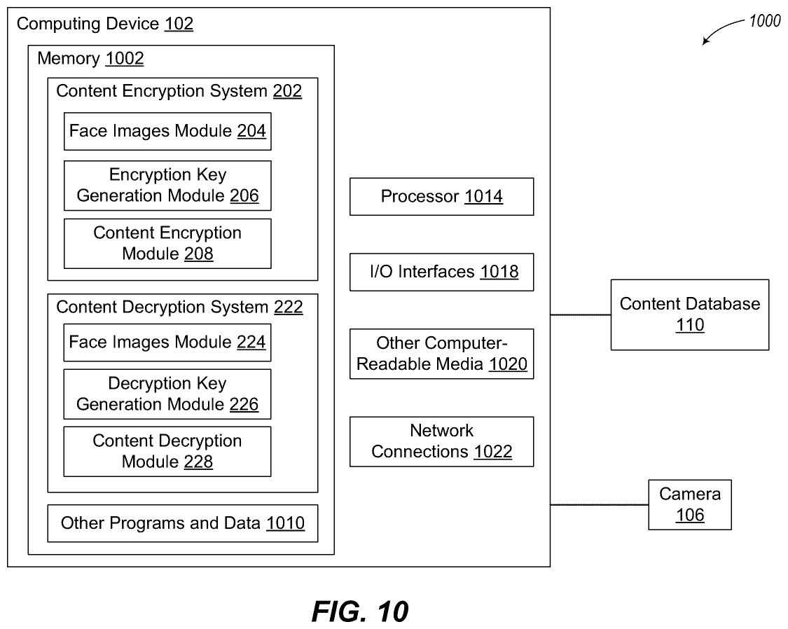

FIG. 10 shows a system diagram that describes one implementation of computing systems for implementing embodiments described herein. System 1000 includes a computing device 102, content database 110, and one or more cameras 106. The computing device 102 obtains images of a person's face and generates a binary cryptographic key for that person, as described herein. One or more special-purpose computing systems may be used to implement the computing device 102. Accordingly, various embodiments described herein may be implemented in software, hardware, firmware, or in some combination thereof. The computing device 102 may include memory 1002, processors 1014, I/O interfaces 1018, other computer-readable media 1020, and network connections 1022.

Processor 1014 may include one or more central processing units, circuitry, or other computing components or units—collectively referred to as a processor or one or more processors—that are configured to performed embodiments described herein or to execute computer instructions to perform embodiments described herein. In some embodiments, a single processor may operate individually to perform embodiments described herein. In other embodiments, a plurality of processors may operate to collectively perform embodiments described herein, such that one or more processors may operate to perform some, but not all, of the embodiments described herein.

Memory 1002 may include one or more various types of non-volatile or volatile storage technologies. Examples of memory 1002 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof.

Memory 1002 is utilized to store information, including computer-readable instructions that are utilized by processor 1014 to perform actions and embodiments described herein. For example, memory 1002 may have stored thereon content encryption system 202 and content decryption system 222.

Content encryption system 202 may include face images module 204, encryption key generation module 206, and content encryption module 208, which are configured to employ embodiments described herein. Although FIG. 10 shows each of these modules as being separate, embodiments are not so limited. Rather, more or fewer modules may be utilized to perform the functionality described herein.

Content decryption system 222 may include face images module 224, decryption key generation module 226, and content decryption module 228, which are configured to employ embodiments described herein. Although FIG. 10 shows each of these modules as being separate, embodiments are not so limited. Rather, more or fewer modules may be utilized to perform the functionality described herein.

Memory 1002 may also store other programs and data 1010 to perform other actions associated with the operation of the computing device 102. For example, in some embodiments the other programs and data 1010 may store selected significant feature indices or binary cryptographic keys for one or more people.

Network connections 1022 are configured to communicate with other computing devices, such as content database 110, or other computing devices not illustrated in this figure. In various embodiments, the network connections 1022 include transmitters and receivers (not illustrated) to send and receive data. I/O interfaces 1018 may include interfaces for accessing or obtaining images captured by camera 106. In various embodiments, the I/O interfaces 1018 may also include a keyboard, audio interfaces, video interfaces, or the like, which may be used to select content that is to be encrypted or to selected previously encrypted content that is to be decrypted. Other computer-readable media 1020 may include other types of stationary or removable computer-readable media, such as removable flash drives, external hard drives, or the like.

Although FIG. 10 illustrates the computing device 102 as a single computing device, embodiments are not so limited. Rather, in some embodiments, a plurality of computing devices may be in communication with one another to provide the functionality of the computing device 102. For example, one computing device may include content encryption system 202, whereas a separate computing device may include content decryption system 222. Examples of computing device 102 may include smart phones, tablet computers, laptop computers, desktop computers, televisions, projectors, set-top-boxes, content receivers, other computing devices, or some combination thereof.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
obtaining a plurality of images of a person's face;
generating a face signature for each of the plurality of images, wherein the face signature includes a plurality of values representative of a plurality of indexed face-signature features;
generating a feature significance statistic for each of the plurality of face-signature features from the plurality of images;
identifying a plurality of possible significant features from the plurality of face-signature features based on the feature significant statistics;
selecting a plurality of significant features from the plurality of possible significant features; and
generating a binary cryptographic key corresponding to the plurality of significant features for at least one of the plurality of images based on the feature significant statistics of the plurality of significant features.

2. The method of claim 1, wherein discarding images from the plurality of images further comprises:
generating a similarity score between each pair of images from the plurality of images; and
for each corresponding image in the plurality of images:
aggregating the similarity scores from each pair of images containing the corresponding image; and
discarding the corresponding image in response to the aggregated similarity score being below a threshold value or identifying the corresponding image as a image in response to the aggregated similarity score being above the threshold value.

3. The method of claim 1, wherein generating the binary cryptographic key further comprises:
generating a first binary cryptographic key corresponding to the plurality of significant features for at least one of the plurality of images;
generating a second binary cryptographic key; and
combining the first binary cryptographic key with the second binary cryptographic key.

4. The method of claim 1, further comprising:
encrypting content using the binary cryptographic key; and
modifying the encrypted content to include the index values of the plurality of significant features.

5. The method of claim 4, further comprising:
obtaining a second plurality of images of the person's face;
generating a second face signature for each of the second plurality of images, wherein the second face signature includes a second plurality of values representative of a second plurality of face-signature features;
discarding images from the second plurality of images having a dissimilar face to result in a second plurality of images;
generating a second feature significance statistic for each of the second plurality of face-signature features from the second plurality of images;
selecting a second plurality of significant features from the second plurality of face-signature features that correspond to the index values of the plurality of significant features;
generating a second binary cryptographic key corresponding to the second plurality of significant features based on the second feature significant statistics of the second plurality of significant features; and
decrypting the encrypted content using the second binary cryptographic key.

6. The method of claim 4, further comprising:
obtaining a second plurality of images of the person's face;
generating a second face signature for each of the second plurality of images, wherein the second face signature includes a second plurality of values representative of a second plurality of face-signature features;
generating a second feature significance statistic for each of the second plurality of face-signature features from the second plurality of images;
selecting a second plurality of significant features from the second plurality of face-signature features that correspond to the index values of the plurality of significant features;
generating a second binary cryptographic key corresponding to the second plurality of significant features based on the feature significant statistics of the plurality of significant features; and
decrypting the encrypted content using the second binary cryptographic key.

7. The method of claim 1, further comprising:
comparing the binary cryptographic key to a previously generated binary cryptographic key for the person; and
positively authenticating the person in response to a match between the binary cryptographic key and the previously generated binary cryptographic key.

8. The method of claim 1, wherein identifying the plurality of possible significant features further comprises:
selecting the plurality of possible significant features from the plurality of face-signature features as those face-signature features having the feature significant statistic above a selected threshold value.

9. The method of claim 1, wherein identifying the plurality of possible significant features further comprises:
selecting the plurality of possible significant features from the plurality of face-signature features as those face-signature features having the feature significant statistic above a selected percentile of the plurality of face-signature features.

10. The method of claim 1, further comprising:
discarding images from the plurality of images having a dissimilar face prior to generating the feature significance statistics for each of the plurality of face-signature features from the plurality of images.

11. The method of claim 1, wherein selecting the plurality of significant features from the plurality of possible significant features further comprises:
randomly selecting the plurality of significant features from the plurality of possible significant features.

12. A computing device, comprising:
a memory configured to store computer instructions; and
a processor configured to execute the computer instructions to:
obtain a plurality of images of a person's face;
generate a face signature for each of the plurality of images, wherein the face signature includes a plurality of values representative of a plurality of indexed face-signature features;
discard images from the plurality of images having a dissimilar face to result in a plurality of satisfactory images;
generate a feature significance statistic for each of the plurality of face-signature features from the plurality of satisfactory images;
identify a plurality of possible significant features from the plurality of face-signature features based on the feature significant statistics;
select a plurality of significant features from the plurality of possible significant features; and
generate a binary cryptographic key corresponding to the plurality of significant features for at least one of the plurality of satisfactory images based on the feature significant statistics of the plurality of significant features.

13. The system of claim 12, wherein the processor discards images from the plurality of images by being configured to further execute the computer instructions to:
generate a similarity score between each pair of images from the plurality of images; and
for each corresponding image in the plurality of images:
aggregate the similarity scores from each pair of images containing the corresponding image; and
discard the corresponding image in response to the aggregated similarity score being below a threshold value or identifying the corresponding image as a satisfactory image in response to the aggregated similarity score being above the threshold value.

14. The system of claim 12, wherein the processor generates the binary cryptographic key by being configured to further execute the computer instructions to:
generate a first binary cryptographic key corresponding to the plurality of significant features for at least one of the plurality of satisfactory images;
generate a second binary cryptographic key; and
combine the first binary cryptographic key with the second binary cryptographic key.

15. The system of claim 12, wherein the processor is configured to further execute the computer instructions to:
encrypt content using the binary cryptographic key; and
modify the encrypted content to include the index values of the plurality of significant features.

16. The system of claim 15, wherein the processor is configured to further execute the computer instructions to:
obtain a second plurality of images of the person's face;
generate a second face signature for each of the second plurality of images, wherein the second face signature includes a second plurality of values representative of a second plurality of face-signature features;
discard images from the second plurality of images having a dissimilar face to result in a second plurality of satisfactory images;
generate a second feature significance statistic for each of the second plurality of face-signature features from the second plurality of satisfactory images;
select a second plurality of significant features from the second plurality of face-signature features that correspond to the index values of the plurality of significant features;
generate a second binary cryptographic key corresponding to the second plurality of significant features based on the feature significant statistics of the plurality of significant features; and
decrypt the encrypted content using the second binary cryptographic key.

17. The system of claim 15, wherein the processor is configured to further execute the computer instructions to:
obtain a second plurality of images of the person's face;
generate a second face signature for each of the second plurality of images, wherein the second face signature includes a second plurality of values representative of a second plurality of face-signature features;
generate a second feature significance statistic for each of the second plurality of face-signature features from the second plurality of images;
select a second plurality of significant features from the second plurality of face-signature features that correspond to the index values of the plurality of significant features;
generate a second binary cryptographic key corresponding to the second plurality of significant features based on the feature significant statistics of the plurality of significant features; and
decrypt the encrypted content using the second binary cryptographic key.

18. The system of claim 12, wherein the processor is configured to further execute the computer instructions to:
compare the binary cryptographic key to a previously generated binary cryptographic key for the person; and
positively authenticate the person in response to a match between the binary cryptographic key and the previously generated binary cryptographic key.

19. The system of claim 12, wherein identifying the plurality of possible significant features further comprises:
selecting the plurality of possible significant features from the plurality of face-signature features as those face-signature features having the feature significant statistic above a selected threshold value.

20. The system of claim 12, wherein the processor identifies the plurality of possible significant features by being configured to further execute the computer instructions to:
select the plurality of possible significant features from the plurality of face-signature features as those face-signature features having the feature significant statistic above a selected percentile of the plurality of face-signature features.

21. A system, comprising:
a camera configured to capture images of a person's face;
a memory configured to store computer instructions; and
a processor configured to execute the computer instructions to:
obtain a plurality of images of the person's face from the camera;
generate a face signature for each of the plurality of images, wherein the face signature includes a plurality of values representative of a plurality of indexed face-signature features;
generate a feature significance statistic for each of the plurality of face-signature features from the plurality of images;
identify a plurality of possible significant features from the plurality of face-signature features based on the feature significant statistics;
select a plurality of significant features from the plurality of possible significant features;
generate a binary cryptographic key corresponding to the plurality of significant features for at least one of the plurality of images;
encrypt content based on the binary cryptographic key; and
modify the encrypted content to identify the index of the plurality of significant features.

22. The system of claim 21, wherein the processor is configured to further execute the computer instructions to:
obtain a second plurality of images of the person's face from the camera;
generate a second face signature for each of the second plurality of images, wherein the second face signature includes a second plurality of values representative of a second plurality of indexed face-signature features;
generate a second feature significance statistic for each of the second plurality of face-signature features from the second plurality of images;
identify a second plurality of possible significant features from the second plurality of face-signature features based on the second feature significant statistics;
select a second plurality of significant features from the second plurality of face-signature features that correspond to the index of the plurality of significant features;
generate a second binary cryptographic key corresponding to the second plurality of significant features based on the feature significant statistics of the plurality of significant features; and
decrypt the encrypted content using the second binary cryptographic key.
